(19) United States
(12) Patent Application Publication
(10) Pub. No.: US 2013/0242330 A1
(43) Pub. Date: Sep. 19, 2013

(54) SHEET POST-PROCESSING APPARATUS AND IMAGE FORMING APPARATUS

(71) Applicant: Ikumi TAKASHIMA, Aichi (JP)

(72) Inventor: Ikumi TAKASHIMA, Aichi (JP)

(73) Assignee: Ricoh Company, Limited, Tokyo (JP)

(21) Appl. No.: 13/798,801

(22) Filed: Mar. 13, 2013

(30) Foreign Application Priority Data
Mar. 14, 2012 (JP) 2012-057257
Nov. 19, 2012 (JP) 2012-253025

(51) Int. Cl. H04N 1/00

(52) U.S. Cl. CPC H04N 1/0057
USPC 358/1.13; 271/3.14

(57) ABSTRACT

A sheet post-processing apparatus includes a first conveying unit configured to convey a sheet; a holding unit configured to hold the sheet conveyed by the first conveying unit; a first post-processing unit configured to perform a post-process on the sheet conveyed by the first conveying unit; a second post-processing unit configured to perform a post-process on the sheet conveyed by the first conveying unit, the second post-processing unit being arranged below the first post-processing unit; a moving unit configured to move the holding unit from the first post-processing unit to the second post-processing unit; a second conveying unit configured to convey the sheet subjected to the post-processed by the first post-processing unit or the second post-processing unit in a direction orthogonal to a direction in which the sheet is conveyed by the first conveying unit; and a stacking unit configured to stack the sheet conveyed by the second conveying unit.

### CROSS-REFERENCE TO RELATED APPLICATIONS

The present application claims priority to and incorporates by reference the entire contents of Japanese Patent Application No. 2012-057257 filed in Japan on Mar. 14, 2012 and Japanese Patent Application No. 2012-253025 filed in Japan on Nov. 19, 2012.

### BACKGROUND OF THE INVENTION

1. Field of the Invention

The present invention relates to a sheet post-processing apparatus and an image forming apparatus.

2. Description of the Related Art

In image forming apparatuses such as a laser printer and a color image copying machine using the electrophotographic process, in general, the following method is adopted. Image data input from a personal computer or an image input device is exposed by a laser or the like to form an electrostatic latent image on an image carrier such as a photosensitive drum. Toner is developed by a developing device and then transferred to a sheet such as a form. The toner is then fused onto the sheet by a fixing unit of the heating roller type or the like to fix an image, and the sheet is discharged.

Image forming apparatuses aiming at automation of operations are also provided. These apparatuses are connected with a post-processing apparatus for performing post-processing including stapling, punching, sorting (gathering), bookbinding, and folding. Sheet post-processing by the post-processing apparatus includes stacking processing for sorting sheets for every copy and stacking them on a discharge tray and stapling processing for stapling post-processed sheets for every predetermined number of sheets and stacking them on a stack tray.

As an image forming apparatus equipped with a post-processing apparatus, an image forming apparatus disclosed in Japanese Patent No. 4199203 is known for example. The image forming apparatus includes a document scanning unit arranged at the top of the apparatus body, a paper feeding unit arranged at the bottom of the apparatus body, a printing unit arranged in between the document scanning unit and the paper feeding unit, a sheet post-processing unit that can perform a plurality pieces of sheet post-processing on sheets that are conveyed from the apparatus body after being printed by the printing unit, and a discharging unit to which the sheets after post-processing are discharged, both units arranged in a space within the apparatus body.

In the image forming apparatus disclosed in Japanese Patent No. 4199203, however, when sheets are conveyed from the apparatus body through the short edge feed (SEF), post processing can be performed on the short edge side that orthogonal to the sheet conveying direction, but not on the long edge side that is parallel to the sheet conveying direction. There is also a problem that, because a punching unit and a staple unit in the sheet post-processing unit are collaterally arranged in the horizontal direction, the apparatus body has a large lateral size.

Therefore, there is a need to provide a sheet post-processing apparatus that can incorporate a plurality pieces of post-processing units for performing post-processing on sheets in a space-saving manner, switch the sheet conveying direction smoothly, and perform post-processing on sheets without degrading productivity and to provide an image forming apparatus including the post-processing apparatus.

### SUMMARY OF THE INVENTION

It is an object of the present invention to at least partially solve the problems in the conventional technology.

According to an embodiment, there is provided a sheet post-processing apparatus that includes a first conveying unit configured to convey a sheet; a holding unit configured to hold the sheet conveyed by the first conveying unit; a first post-processing unit configured to perform a post-process on the sheet conveyed by the first conveying unit; a second post-processing unit configured to perform a post-process on the sheet conveyed by the first conveying unit, the second post-processing unit being arranged below the first post-processing unit; a moving unit configured to move the holding unit from the first post-processing unit to the second post-processing unit; a second conveying unit configured to convey the sheet subjected to the post-processed by the first post-processing unit or the second post-processing unit in a direction orthogonal to a direction in which the sheet is conveyed by the first conveying unit; and a stacking unit configured to stack the sheet conveyed by the second conveying unit.

According to another embodiment, there is provided an image forming apparatus that includes an image scanning unit configured to read image information; an image forming unit configured to form an image on a sheet based on the read image, the image forming unit being arranged below the image scanning unit; and the sheet post-processing apparatus according to the above embodiment, arranged in between the image scanning unit and the image forming unit, wherein the sheet on which the image has been formed is conveyed to the first conveying unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram illustrating an image forming apparatus including a sheet post-processing apparatus in an embodiment of the present invention;

FIG. 2 is a schematic configuration diagram of the sheet post-processing apparatus in the image forming apparatus in FIG. 1 when viewed from the X-X line cross sectional direction;

FIG. 3 is a diagram illustrating the sheet post-processing apparatus when viewed from above;

FIG. 4 is a schematic configuration diagram of the sheet post-processing apparatus when viewed from above with a viewpoint different from FIG. 3 (a 90°-rotated viewpoint);

FIGS. 5A and 5B are operational schematic diagrams of entrance rollers, driven rollers, an entrance slide guide plate, and a clamp unit in the sheet post-processing apparatus;

FIGS. 6A and 6B are operational schematic diagrams of the entrance rollers, driven rollers, entrance slide guide plate, and clamp unit in the sheet post-processing apparatus;

FIGS. 7A and 7B are operational schematic diagrams of the entrance rollers, driven rollers, entrance slide guide plate, and clamp unit in the sheet post-processing apparatus;

FIGS. 8A and 8B are operational schematic diagrams of the entrance rollers, driven rollers, entrance slide guide plate, and clamp unit in the sheet post-processing apparatus;

FIG. 9 is a configuration diagram of one of the entrance rollers, one of the driven roller, and the entrance slide guide plate in the sheet post-processing apparatus;

FIG. 10 illustrates the operational process of the clamp unit in the sheet post-processing apparatus;

FIG. 11 is a schematic diagram of the clamp unit in the sheet post-processing apparatus; and

FIGS. 12A and 12B are schematic configuration diagrams of a clamp in the clamp unit, FIG. 12A illustrating a state when the clamp is closed and FIG. 12B illustrating another state when the clamp is open.

### DETAILED DESCRIPTION OF THE PREFERRED EMBODIMENTS

Hereinafter, an embodiment of an image forming apparatus including a sheet post-processing apparatus according to the present invention will be described with reference to the accompanying drawings.

Overall Configuration

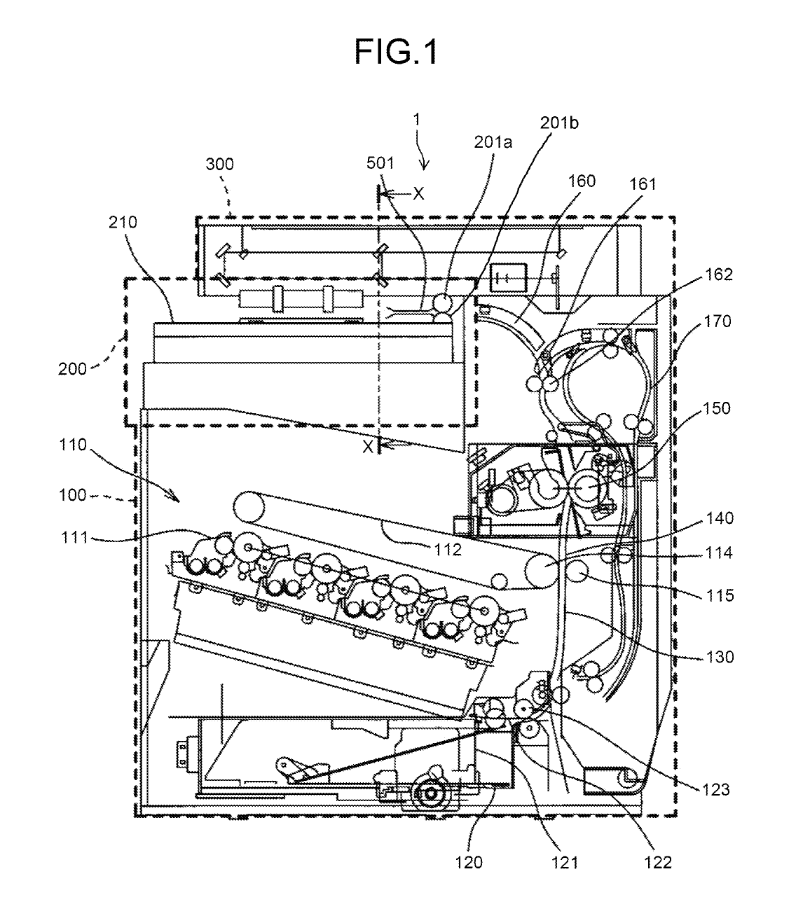

FIG. 1 is a schematic configuration diagram illustrating one embodiment of an image forming apparatus including a sheet post-processing apparatus in the embodiment. In FIG. 1, this image forming apparatus 1 includes an image forming unit 100, a sheet post-processing apparatus 200, and an image scanning unit 300. In the following, parts other than the sheet post-processing apparatus 200 and a discharge tray 210 will be referred to as the apparatus body for convenience.

The image forming unit 100 is what is called a tandem-type color image forming unit of the indirect transfer type. The image forming unit 100 includes an image forming part 110 around whose central part a four-color image forming station 111 is arranged, an optical writing unit (not illustrated) that is provided adjacently below the image forming part 110, a paper feeding unit 120 that is provided below the image forming part 110, a feeding conveying path (vertical conveying path) 130 that conveys a sheet picked up by the paper feeding unit 120 to a secondary transfer unit 140 and a fixing unit 150, a discharging conveying path 160 that conveys the sheet on which an image is fixed to the sheet post-processing apparatus 200 side, and a duplex conveying path 170 that reverses the sheet with the image formed on its one surface and allows image formation on the other surface.

The image forming part 110 includes photosensitive drums for each of the YMCK (Y: yellow, M: magenta, C: cyan, and K: black) colors of the image forming station 111, a charging unit, a developing unit, a primary transfer unit, a cleaning unit, and a neutralization unit, each of which is arranged along the perimeter of the photosensitive drum, an intermediate transfer belt 112 that intermediately transfers an image formed on the photosensitive drum using the primary transfer unit, and an optical writing unit that writes an image onto each photosensitive drum for the corresponding color. The optical writing unit is arranged below the image forming station 111, while the intermediate transfer belt 112 is arranged above the image forming station 111. The intermediate transfer belt 112 is rotatably supported by a plurality of support rollers, one support roller 114 of which faces a secondary transfer roller 115 through the intermediate transfer belt 112, thereby allowing an image on the intermediate transfer belt 112 to be secondarily transferred to the sheet. Because the image forming process of the tandem-type color image forming unit of the indirect transfer type is publicly known, and it does not directly relate to the subject of the present invention, its detailed description will be omitted.

The paper feeding unit 120 includes a paper feed tray 121, a pick-up roller 122, and a feeding conveying roller 123, and feeds a sheet picked up from the paper feed tray 121 upward along the vertical conveying path 130. An image is transferred to the fed sheet in the secondary transfer unit 140, and the sheet is fed into the fixing unit 150. The fixing unit 150 includes a fixing roller and a pressing roller. When the sheet passes through the nip between both rollers, the fixing unit 150 applies heat and pressure on the sheet, thereby allowing toner to be fixed onto the sheet.

The discharging conveying path 160 and the duplex conveying path 170 are provided at the downstream of the fixing unit 150. Both paths are bifurcated into two directions by a bifurcating claw 161, thereby allowing the sheet conveying path to be selected between a case of the sheet being conveyed to the sheet post-processing apparatus 200 side or a case of the sheet being conveyed to the duplex conveying path 170. At the direct upstream side of the bifurcating claw 161 in the sheet conveying direction, provided is bifurcating conveying rollers 162, thereby exerting a conveying force to the sheet.

The sheet post-processing apparatus 200 is arranged in a space formed in between the image forming unit 100 and the image scanning unit 300 of the apparatus body. The sheet post-processing apparatus 200 performs predetermined post-processing on a sheet with an image formed thereon conveyed from the image forming unit 100 and stacks the sheet on the discharge tray 210 that is positioned at the endpoint, details of which will be describe later.

The image scanning unit 300 optically scans a document set on a contact glass and reads an image on the document surface. Because the structure and functions of the image scanning unit 300 are publicly known, and it does not directly relate to the subject of the present invention, its detailed description will be omitted.

In the image forming unit 100 configured as outlined above, image data to be used in writing is generated based on document data read by the image scanning unit 300 or print data transferred from an external PC and the like. Based on the image data, the optical writing unit performs optical writing on each photosensitive drum. Images formed on each photosensitive drum for the corresponding color are successively transferred to the intermediate transfer belt 112, and a color image on which images with four colors are superimposed is formed on the intermediate transfer belt 112. A sheet is fed from the paper feed tray 121 in accordance with the image formation. The sheet is temporarily stopped at the position of a registration roller (not illustrated) right in front of the secondary transfer unit 140, is fed in synchronization with the leading end of an image on the intermediate transfer belt 112, is secondarily transferred by the secondary transfer unit 140, and is fed into the fixing unit 150.

The sheet on which the image has been fixed by the fixing unit 150 is conveyed, by the switching operation of the bifurcating claw 161, to the discharging conveying path 160 side for the time after the printing of single-sided printing and the time after the printing of duplex printing, and is conveyed to the duplex conveying path 170 side for the time after the single-sided printing of duplex printing. The sheet conveyed to the duplex conveying path 170 after single-sided printing is, after being reversed, fed finally into the secondary transfer unit 140, where an image is formed on the blank side, and is then sent back to the discharging conveying path 160 side. The sheet conveyed to the discharging conveying path 160 side is conveyed to the sheet post-processing apparatus 200, and is, after being subjected to predetermined post-processing or without post-processing, discharged to the discharge tray 210.

Sheet Post-Processing Unit

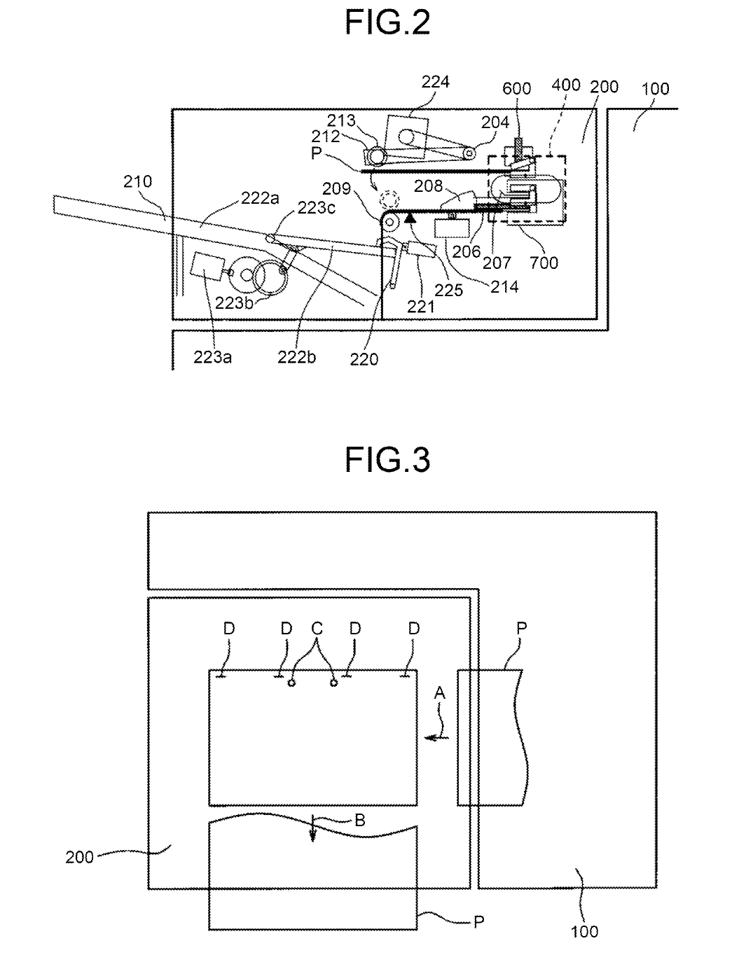

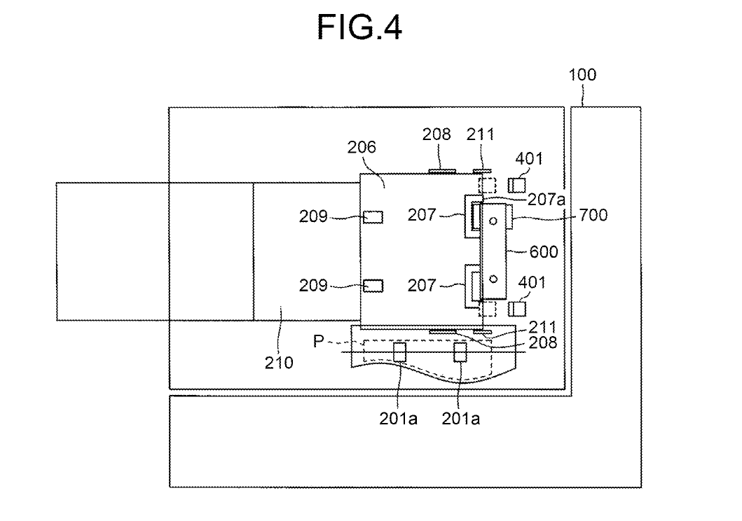

FIG. 2 is a schematic configuration diagram of the sheet post-processing apparatus 200 viewed along the X-X line cross sectional direction in the image forming apparatus in FIG. 1. FIG. 3 is a diagram illustrating the sheet post-processing apparatus 200 when viewed from above. FIG. 4 is a schematic configuration diagram of the sheet post-processing apparatus 200 when viewed from above with a viewpoint different from FIG. 3 (a 90°-rotated viewpoint). The sheet post-processing apparatus 200 includes mainly, in order from the upstream side in the sheet conveying direction, an entrance roller 201a, a driven roller 201b, and a feed guiding plate 501 as a first conveying unit; punch jogger fences (alignment plates) 211; a clamp unit 400 as a holding unit and a moving unit; a punching unit 600 as a first post-processing unit; a stapling unit 700, a stapling tray 206, trailing-end reference fences 207, and staple jogger fences (alignment plates) 208 as a second post-processing unit; discharging rollers 209 as a second conveying unit; and the discharge tray 210 as a stacking unit. A punch stage including the punching unit 600 and a staple stage including the stapling unit 700 and the stapling tray 206 are vertically arranged. Vertical arrangement of a plurality of post-processing units prevents an increase in the lateral size of the image forming apparatus 1. The clamp unit 400 is configured, as described later, so that two clamps 401 as holding units pass a sheet P between the punching unit 600 and the stapling unit 700.

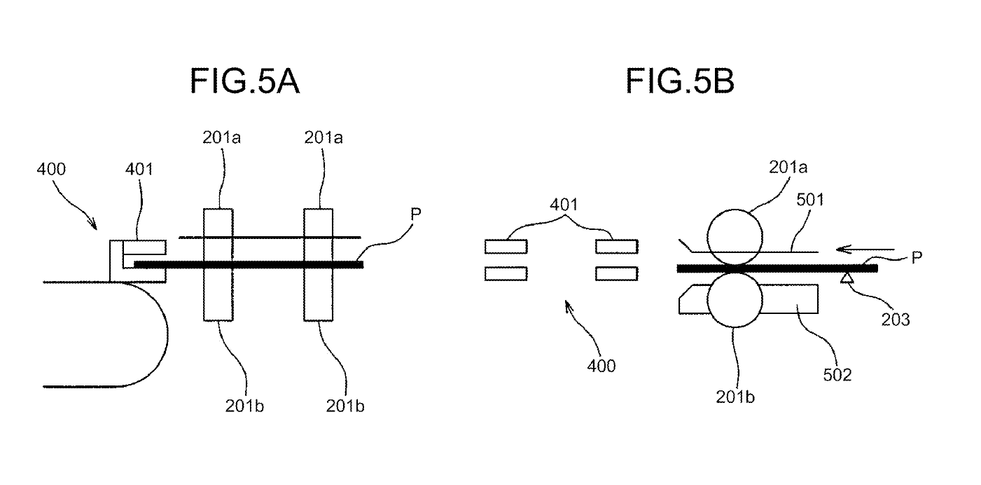

A sheet receiving unit of the sheet post-processing apparatus 200 includes a pair of entrance rollers 201a that receive the sheet P from the discharging conveying path 160 of the image forming unit 100 and a feed guiding plate 501 for conveying the received sheet to the punching unit 600. The sheet is conveyed along the feed guiding plate 501 through rotation of the pair of entrance rollers 201a by an entrance motor (not illustrated). At the upstream side of the pair of entrance rollers 201, arranged is an entrance sensor 203 (see FIGS. 5A and 5B). The entrance sensor 203 detects the leading end and trailing end of the sheet received by the pair of entrance rollers 201a and determines the timing for performing each sheet processing based on the detection timing of the leading end and trailing end of the detected sheet and the step number of the driving of the entrance motor, which is a stepping motor. The pair of entrance rollers 201a provided along the conveying path function as a conveying unit.

In the configuration of the sheet post-processing apparatus 200 at the downstream of the pair of entrance rollers 201, as illustrated by the arrow A in FIG. 3 along the sheet conveying direction, the sheet P having a short edge and a long edge (for example, an A4 sheet) is received from the image forming unit 100 through SEF. Post-processing on punch hole positions C by the punching unit 600 and post-processing on stapling positions D by the stapling unit 700 are then performed in the vicinity of the long edge that is parallel to the conveying direction A. At the downstream of the punching unit 600 and the stapling unit 700, the conveying direction of the sheet P is switched by the discharging rollers 209 to the orthogonal direction (the arrow B) with respect to the conveying direction A from the image forming unit 100, and processing on the sheet P is performed through long edge feed (LEF).

The sheet P discharged from the pair of entrance rollers 201a enters the punch stage with one edge (the upper long edge in FIG. 3) supported by the clamps 401 on the punching unit 600 side and with the other edge (the lower long edge in FIG. 3) supported by the staple tray 206. The leading and trailing ends of the sheet are aligned by the punch jogger fences 211. The sheet P is positioned by allowing its sheet trailing end to be abutted against an abutting member 411 in each of the two clamps 401 included in the clamp unit 400, held by the clamps 401, and then punched by the punching unit 600. After the punching, one of the sheet long edges is pushed out of the punching unit 600 by the clamp unit 400 and falls toward the staple stage. In a mode where punching is not performed, one of the sheet long edges falls toward the staple stage without punching operation by the punching unit 600 during the above-described punching operation.

After one of the sheet long edges falls from the punch stage to the staple stage, and the entire sheet is placed on the staple tray 206, process differs depending on shift modes, one that shifts and discharges a sheet and the other that staples a plurality of sheets and discharges them. Each mode will be described together with its corresponding structure.

Shift Mode

The shift mode is a mode in which, without a punching process or a stapling process performed on sheets, the discharging position is shifted along the direction perpendicular to the sheet conveying direction when the sheets are discharged on the discharge tray 210, and the sheets are sorted for every predetermined number of sheets.

As illustrated in FIG. 4, the staple tray 206 includes two trailing-end reference fences 207 and two staple jogger fences (alignment plates) 208. The two trailing-end reference fences 207 are formed in a right-opening U shape in the top view as illustrated in FIG. 4 and formed in a left-opening U shape in the side view, and are fixed to the end on the stapling unit 700 side of the staple tray 206 so that an abutting surface 207a projects vertically further upward than the plane of the staple tray 206. The two staple jogger fences (alignment plates) 208 are disposed within a guide shaft (not illustrated) fixed to the staple tray 206. Furthermore, the two staple jogger fences (alignment plates) 208 are coupled to a stepping motor 214 through a timing belt (not illustrated) and linearly reciprocate by the forward and backward rotational drive of the stepping motor 214, each of which can be driven independently.

After the sheet falls to the staple stage, one of the long edges (the right-hand long edge in FIG. 4) is abutted against the trailing-end reference fences 207, whereby alignment in the conveying direction (the arrow B in FIG. 2) on the staple stage is performed. Alignment in a direction orthogonal to the conveying direction (the arrow B) is performed by the staple jogger fences 208. A discharging guide plate 212 and the discharging rollers 209 are arranged at the downstream of the staple stage. The discharging guide plate 212 can move vertically by a stepping motor 224 and a pulley 204 that is belt-driven by the stepping motor 224. The sheet is conveyed while being held between the discharging rollers 209 and a driven roller 213 attached to the discharging guide plate 212, is discharged to the discharge tray 210, and is stacked on the discharge tray 210. When sheets are sorted for every predetermined number of sheets, the sheets are discharged to the discharge tray 210 with a shift corresponding to the movement of the alignment position (the position of the staple jogger fences 208) in a direction orthogonal to the conveying direction on the staple stage. As a result, when the sheets are stacked on the discharge tray 210, the discharging positions are alternately shifted for the every predetermined number of sheets, thereby allowing the sheets to be sorted.

A sheet retainer 220 for retaining sheets stacked on the discharge tray 210 is arranged at the mounting part of the discharge tray 210 to the body part of the sheet post-processing apparatus 200. Sheet retaining release operation and sheet retaining operation are performed by turning on and off of a solenoid 221. In other words, the solenoid 221 is turned on in accordance with the feeding of a sheet to release the pressing operation of the sheet retainer 220. When the sheet trailing end passes through the discharging rollers 209, the solenoid 221 is turned off to perform sheet retaining.

The discharge tray 210 includes a fixed tray unit 222a at the downstream side in the conveying direction and a movable tray unit 222b at the upstream side. The movable tray unit 222b moves vertically by a tray DC motor 223a and a cam and link mechanism 223b. The movable tray unit 222b is pivotally supported in an oscillatable manner by the fixed tray unit 222a through a pivot 223c with its end at the upstream side being an oscillating end. The working end of the cam and link mechanism 223b is connected to the movable tray unit 222b. An end of the movable tray unit 222b at the upstream side in the sheet conveying direction is a free end. As a result, when the tray DC motor 223a rotates, the movable tray unit 222b, in accordance with the rotation, oscillates about the pivot 223c. When the number of discharged sheets amounts to a predetermined number, the tray DC motor 223a rotates through an instruction from a control unit, which will be described later, thereby moving downward the movable tray unit 222b.

A tray sheet surface sensor (not illustrated) is arranged on the sheet retainer 220. When the tray sheet surface sensor is off while sheet retaining is performed by the sheet retainer 220, the free end of the movable tray unit 222b is moved upward until the tray sheet surface sensor is turned on. When the tray sheet surface sensor is on, the free end of the movable tray unit 222b is moved downward once until the sheet surface sensor is turned on, and then moved upward until it is turned on again, thereby maintaining the height of the free end of the movable tray unit 222b in the discharge tray 210 on which sheets (or a batch of sheets) are stacked constant.

By thus moving upward and downward the free end of the movable tray unit 222b in accordance with the sheet stacking condition of the discharge tray 210 and maintaining the distance from the nip of the discharging rollers 209 to the sheet stacking unit of the movable tray unit 222b constant, the contact angle between a sheet discharged from the discharging rollers 209 and the movable tray unit 222b can be kept constant so as to stabilize the alignment quality of the sheets stacked on the discharge tray 210 and allow stacking of a large number of sheets. By repeating the foregoing operation, sorted sheets are stacked on the discharge tray 210.

Staple Mode

The staple mode is a mode, in which when sheets are discharged, they are stapled by the stapling unit 700 for every predetermined number of sheets and are discharged. In the staple mode, one of the sheet long edges is pushed out of the punching unit 600 by the two clamps 401, and the two clamps 401 move until the one of the sheet long edges abuts against the trailing-end reference fences 207 through the vertical operation of the clamp unit 400, which will be described later, thereby performing alignment in the conveying direction on the staple stage. This alignment is performed based on the trailing-end reference fences 207.

At the completion of the abutting of the one of the sheet long edges, sheet alignment in the direction perpendicular to the sheet conveying direction on the staple stage by the staple jogger fences 208 arranged on the staple tray 206 described above in the description of the shift mode is performed.

The staple tray 206 includes a home sensor (not illustrated) that detects a standby position of the staple jogger fences (alignment plates) 208. The staple tray 206 is also provided with trailing-end reference fences 207 through a slider (not illustrated) on a guide shaft (not illustrated), and they can move in the same direction as the staple jogger fences (alignment plates) 208. A rack (not illustrated) is held by the slider and is coupled to a gear (not illustrated) that is arranged nearly at the center of the staple tray 206, thereby allowing the trailing-end reference fences 207 to move symmetrically with respect to the gear.

A guide is provided at the end of the trailing-end reference fences 207. A base (not illustrated) of the stapling unit 700 hooks the inside of the guide through the movement of the stapling unit 700, thereby allowing the trailing-end reference fences 207 to follow. When the stapling unit 700 moves in a direction toward the end of the staple tray 206, the separation between the trailing-end reference fences 207 becomes larger. When the stapler moves to the center of the staple tray 206, because the trailing-end reference fences 207 are biased toward the center of the staple tray 206 by a spring (not illustrated), the separation between the trailing-end reference fences 207 becomes smaller.

After stapling processing, the discharging guide plate 212 is moved downward to hold a batch of sheets by the discharging rollers 209 and the driven roller 213 attached to the discharging guide plate 212, and the batch of sheets are discharged to the discharge tray 210. While the batch of sheets is being discharged, the solenoid 221 is turned on to release the sheet retainer 220, and the movable tray unit 222b is moved downward by a predetermined amount. Next, the discharging guide plate 212 is moved upward with such timing that the trailing end of the batch of sheets passes through a batch discharge sensor 225 to prepare for the reception of the next sheet. The solenoid 221 turned off with the same timing to perform sheet retaining.

Next, FIGS. 5A to 8B are operational schematic diagrams of the entrance rollers 201a, the driven rollers 201b, and an entrance slide guide plate 502. In each drawing, A is a schematic diagram viewed from the upstream side in the sheet conveying direction, while B is a schematic diagram viewed from a direction orthogonal to the sheet conveying direction. The sheet conveyed by the pair of entrance rollers 201a undergoes shift operation to allow the sheet end to enter the punching unit 600. The shift function is a shift mechanism having the entrance rollers 201a and the driven rollers 201b that come into contact with the entrance rollers 201a to form a nip for holding and conveying the sheet. The entrance rollers 201a are provided movably in its axial direction by an entrance roller driving source such as a motor, while the driven rollers 201b are provided movably in its axial direction in accordance with the movement of the entrance rollers 201a.

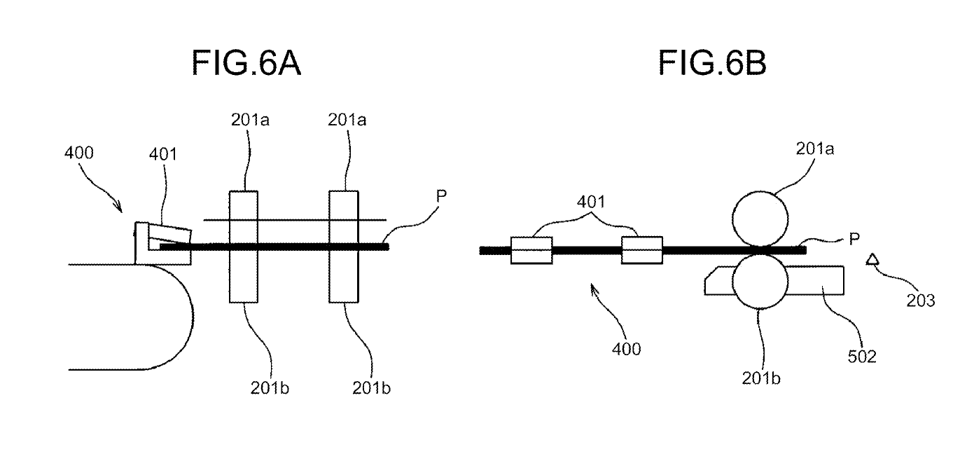

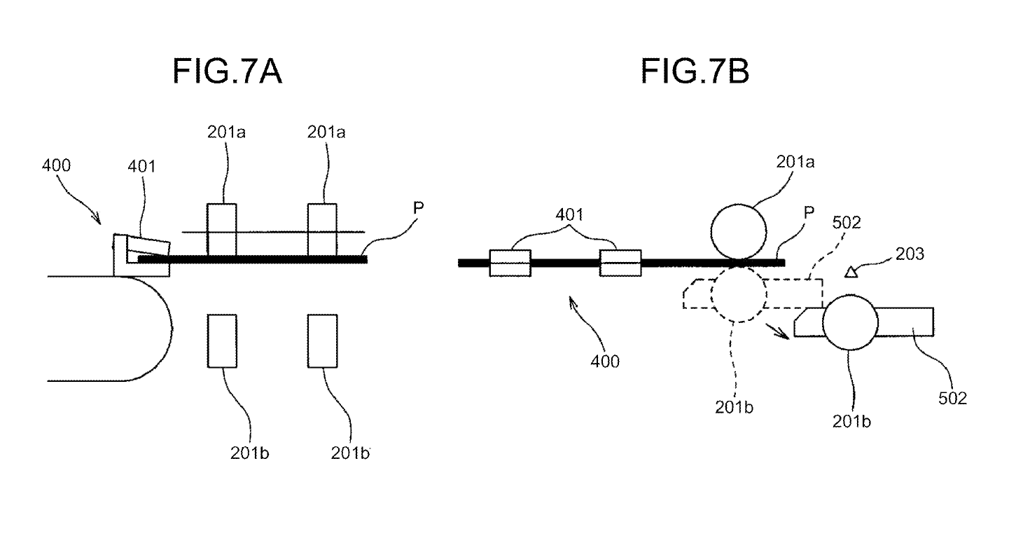

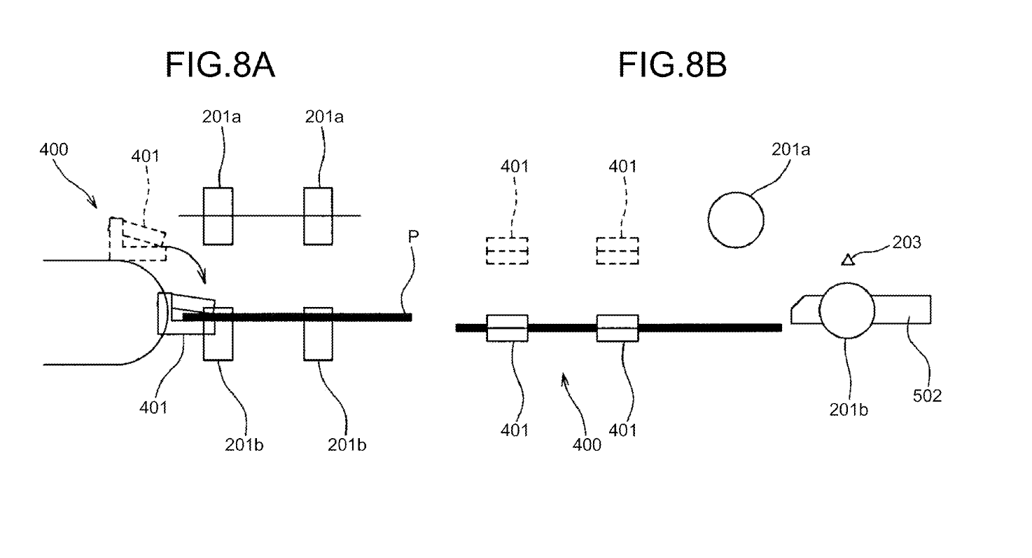

First, after conveying the end of the sheet P to the punching unit 600 by the entrance rollers 201a and the driven rollers 201b (see FIGS. 5A and 5B), the conveying unit is switched from the entrance rollers 201a to the clamp unit 400 (see FIGS. 6A and 6B). The entrance rollers 201a stop while holding the trailing end of the sheet P, and when the two clamps 401 hold the sheet P, the driven rollers 201b that are rotatably attached to the entrance slide guide plate 502 move obliquely downward at the upstream side in the sheet conveying direction, thereby allowing the entrance rollers 201a to release pressure and allowing conveying by the two clamps 401 (see FIGS. 7A and 7B). For the sheet P held by the two clamps 401, the leading end (the short edge) of the sheet P is drawn to the punch jogger fences (the alignment plates) 211 of the punch stage, and one of the long edges of the sheet P is abutted against the abutting plates of the two clamps 401 to be aligned, and is punched by the punching unit 600. After the punching, the clamp unit 400 moves along the guide (see FIGS. 8A and 8B), and pushes the sheet P held by the two clamps 401 out of the punching unit 600. The sheet P that has been pushed out moves to the staple stage arranged below the punch stage in accordance with the movement of the two clamps 401. The entrance slide guide plate 502 is in advance slid and retreated to a position that does not interfere with the falling path of the sheet P (see FIGS. 7A and 7B).

When the sheet P moves to the staple stage, it moves to the sheet trailing-end abutting surfaces of the trailing-end reference fences 207 while being held by the two clamps 401, and when the trailing end of the sheet P reaches the abutting surfaces 207a of the trailing-end reference fences 207, the two clamps 401 open. The entrance slide guide plate 502 is slid and returned to the original position, and this operation supplies pressure for the driven rollers 201b, thereby allowing the next sheet to be received.

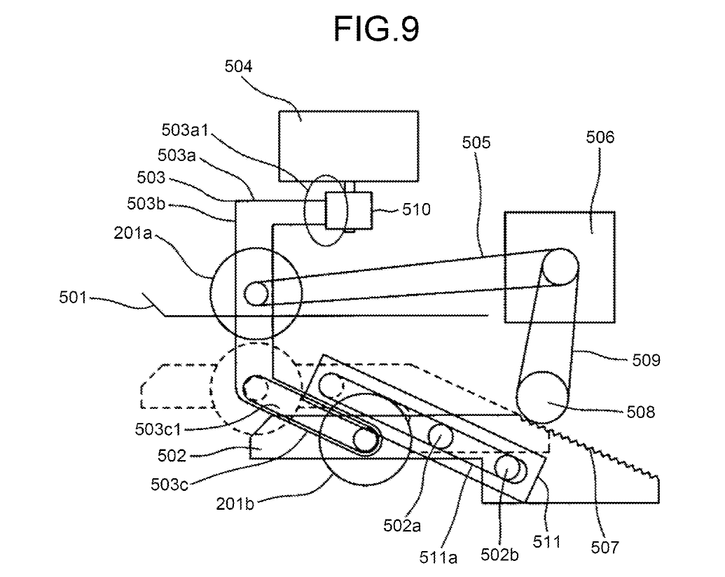

FIG. 9 is a configuration diagram of one of the entrance rollers 201a and the entrance slide guide plate 502. The entrance rollers 201a are coupled to a stepping motor 506 as the entrance roller driving source through a timing belt 505, and rotates by the forward rotation of the stepping motor 506. Both the entrance roller 201a and the driven roller 201b are coupled with a coupling member 503. The coupling member 503 includes a first part 503a that is parallel to the conveying direction of the sheet P conveyed by the entrance roller 201a, a second part 503b that is extended from the first part 503a in a direction orthogonal to the conveying direction of the sheet P, and a third part 503c that is extended from the second part 503b obliquely downward in the upstream direction, and is formed in nearly a left-opening U shape. The entrance roller 201a is rotatably attached to the second part 503b. A slot 503c1 (or may be a long channel) is formed in the third part 503c, which supports the shaft of the driven roller 201b rotatably and slidably from the end that is connected to the second part 503b to the tip side. A rack 503a1 whose teeth form a line in a direction parallel to the axial direction of the entrance roller 201a is formed at the end of the first part 503a of the coupling member 503. The rack 503a1 meshes with a pinion 510 that is fixed to the rotating shaft of the motor 504 and is rotatably driven by the motor 504, thereby allowing both the entrance roller 201a and the driven roller 201b to move in the axial direction and allowing the shift operation.

The driven roller 201b is rotatably attached to the entrance slide guide plate 502 as a guide plate. The entrance slide guide plate 502 includes guide pins 502a and 502b that project toward the near side of the sheet of FIG. 9. The guide pins 502a and 502b are slidably freely fit into a slot 511a that is provided in a slide guide plate 511 fixed to an appropriated position of the apparatus body and inclined obliquely downward in the upstream direction with respect to the conveying direction of the sheet P conveyed by the entrance roller 201a. The entrance slide guide plate 502 is also provided with a rack 507 that is inclined obliquely downward in the upstream direction with respect to the conveying direction of the sheet P conveyed by the entrance roller 201a. The rack 507 is coupled to the stepping motor 506 as a nip formation release driving source through a pinion with a torque limiter 508 and a timing belt 509. In other words, the stepping motor 506 is a common driving source as the entrance roller driving source and the nip formation release driving source. By the backward rotation of the stepping motor 506, the entrance slide guide plate 502 slides obliquely downward in the upstream direction, thereby allowing the driven roller 201b to release pressure against the entrance roller 201a. When the stepping motor forwardly rotates, the entrance slide guide plate 502 slides obliquely upward in the downstream direction, thereby allowing the driven roller 201b to come into contact with the entrance roller 201a and produce pressure. The torque limiter is activated by the pressure, thereby preventing the rotational force of the stepping motor 506 from being transmitted to the pinion 508.

The driven roller 201b thus moves obliquely in the upstream direction by the nip formation release unit having the stepping motor 506 as the nip formation release driving source, the rack 507 of the entrance slide guide plate 502, the torque-limiter-equipped pinion 508 and the timing belt 509, thereby releasing the formation of the nip with the entrance roller 201a. Accordingly, because the retreat of the driven roller 201b is performed in the linear movement in the obliquely upstream direction, it follows a less redundant path than the conventional arcuate retreat path of a driven roller through the rotation of a guide plate, and sheet processing can be performed without degrading productivity. Therefore, the sheet conveying direction can be switched smoothly, sheets can be conveyed to the downstream side stably and processing on sheets can be performed.

The drive of the driven roller 201b can be achieved at low cost using the stepping motor 506 for rotating the entrance roller 201a.

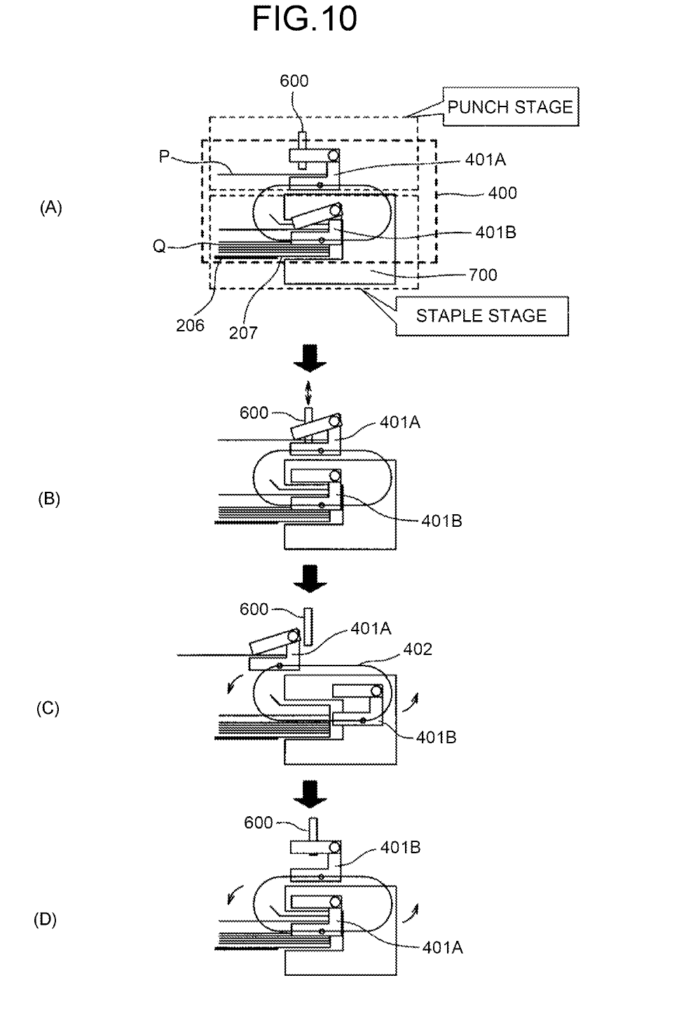

FIG. 10 illustrates the operation of the clamp unit 400. The sheet discharged from the entrance roller 201a enters the punch stage with its one of the long edge supported by the clamp unit 400. The leading end and trailing end of the short edges of the sheet that has entered are aligned by the punch jogger fences 211, and the one of the long edges is abutted against the abutting member 411 of the clamp 401A provided within the clamp unit 400, and is positioned (see FIG. 10(A)). When the sheet is positioned, the clamp 401A is closed to hold the sheet, which is then punched by the punching unit 600 (see FIG. 10(B)). After the punching, the clamp 401A holding the sheet moves along a guide 402. By the movement of the clamp 401A, the held sheet is pushed out of the punching unit 600, moved downward to the staple stage, and guided to the staple stage. The clamp 401B positioned on the staple stage moves to the punch stage along the guide 402 (see FIG. 10(C)).

Arriving at the staple stage, the clamp 401A moves to the abutting surface 207a of each of the trailing-end reference fences 207 while holding the sheet, and when one of the sheet long edges arrives at the abutting surface of each of the trailing-end reference fences 207, releases the holding of the sheet. The clamp 401B waits at the reception position so that the next sheet can be punched at the punch stage (see FIG. 10(D)). Receiving the next sheet, the clamp 401B is closed. After the next sheet is punched, the clamps 401A and 401B move along the guide 402, and by the movement of the clamps 401, the sheet on the clamp 401A is stacked on the staple tray 406.

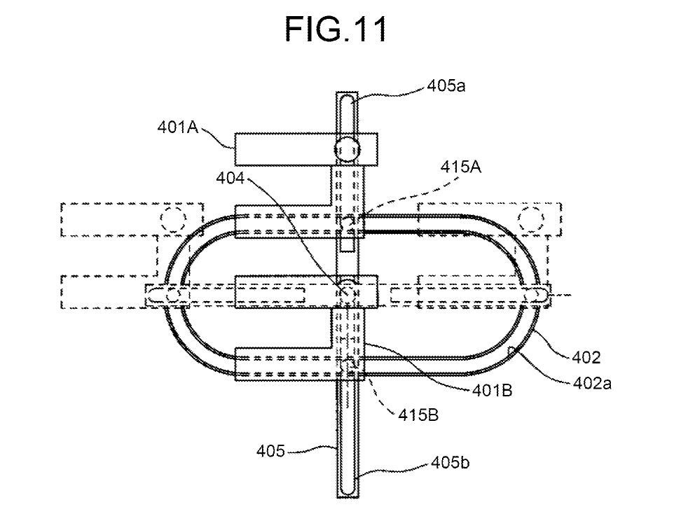

FIG. 11 is a configuration diagram of the clamp unit 400. The clamp unit 400 includes two pairs of clamps 401A and 401B as a holding unit and an elliptic guide 402 and a link 405 as a moving unit. The clamp unit 400 moves vertically and horizontally by allowing the two pairs of clamps 401A and 401B to move along the guide 402 in a circular manner. In FIG. 11, a pair of clamps 401A and 401B correspond to the clamp 401 illustrated in the upper side of FIG. 4, while another pair of clamps 401A and 401B correspond to the clamp 401 illustrated in the lower side of FIG. 4, where only one pair of clamps 401A and 401B will be described.

The link 405 includes a linear arm that is rotatable with the center of rotation 404 that is rotatably driven by a driving source (not illustrated) as the fulcrum, and includes long channels 405a and 405b in between the center of rotation 404 and the arm ends. The guide 402 is a member having an elliptic guide hole 402a. The clamps 401A and 401B have cylindrical guide members 415A and 415B that pass through the guide hole 402a of the guide 402 and are freely fit into the long channels 405a and 405b, respectively. The clamps 401A and 401E operate by allowing the guide members 415A and 415B to move along the long channels 405a and 405b of the link 405 and the guide hole 402a of the guide 402 when the link 405 rotates with the center of rotation 404 as the fulcrum by the rotational drive of a driving source such as a stepping motor (not illustrated). The guide 402, link 405, and driving source of the clamp unit 400 are arranged at positions that do not interfere with sheet conveying. The other pair of clamps 401A and 401B (the clamp 401 in the lower side of FIG. 4), each guide member is coupled to the guide members 415A and 415B coaxially and operates as is the case with the above description.

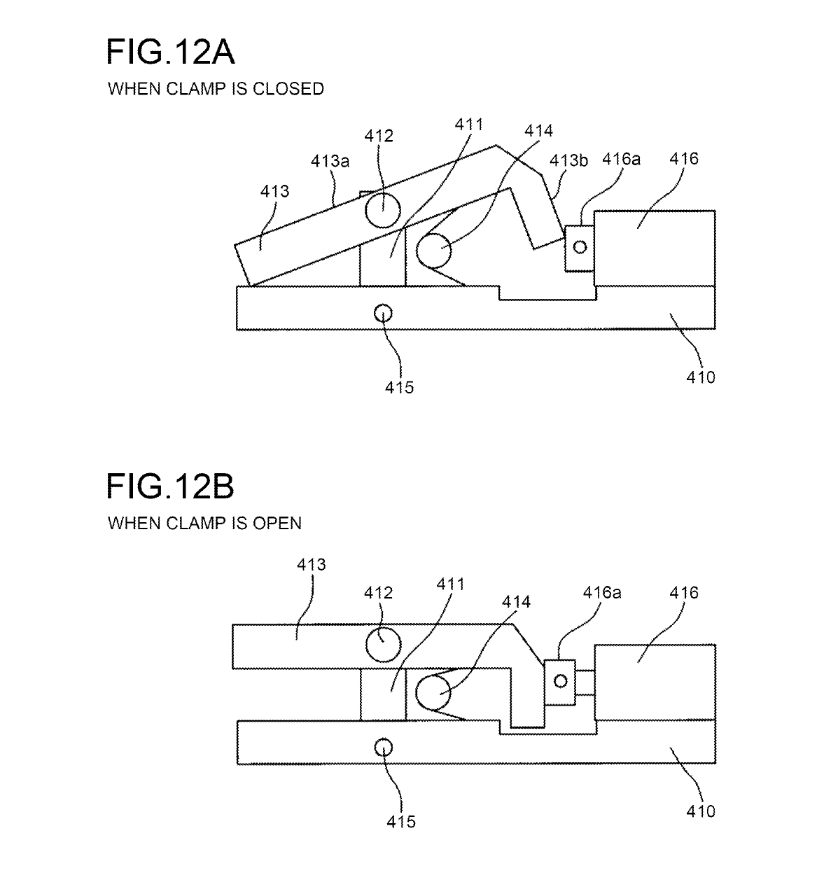

FIGS. 12A and 12B are configuration diagrams of the clamp 401A (401B also has the same configuration). The clamp 401A includes a base 410, an abutting part 411 erected on the base 410, a holding part 413 that is rotatably attached to the abutting part 411 with the center of rotation 412 as the fulcrum, a torsion spring 414 provided in between the base 410 and the holding part 413, a cylindrical guide member 415 that is extended from the base 410 in the orthogonal direction, and a solenoid 416 that is attached on the base 410. The holding part 413 includes an opening and closing part 413a with the center of rotation 412 as the fulcrum and a pressed part 413b that is extended from one end of the opening and closing part 413a and bent. When the holding part 413 is closed, the clamp 401A has pressure exerted to hold a sheet by the torsion spring 414. When opening the holding part 413, the action of the projection of an actuator 416a of the solenoid 416 presses an end of the opening and closing part 413a, thereby rotating the holding part with the center of rotation 412 as the fulcrum and opening it.

As described above, according to the sheet post-processing apparatus in the embodiment, a sheet that is conveyed by the first conveying unit and post-processed by the first post-processing unit is moved by the holding unit and the moving unit, and a second conveying unit is provided, which conveys the sheet post-processed by the second post-processing unit in a conveying direction orthogonal to the conveying direction conveyed from the image forming unit, where the second conveying unit conveys the sheet conveyed from the image forming apparatus with its one of the short edge and long edge being at the head and post-processed by the first or second post-processing unit to the stacking unit with the other one of the short edge and long edge of the sheet at the head, thereby allowing a plurality of post-processing functions to be arranged in a space-saving manner, switching the sheet conveying direction smoothly, and allowing processing on sheets without degrading productivity by eliminating redundant operation.

Although the embodiment of the present invention has been described above, the present invention is not limited thereto, and various alternations and applications are possible. As far as those alternations and applications are provided with the constituents of the present invention, they are included within the scope of the present invention.

For example, in the sheet post-processing apparatus 200 of the above-described embodiment, the sheet P having a short edge and long edge (for example, an A4 sheet) is received from the image forming unit 100 through SEF, the conveying direction of the sheet P after the post-processing is switched to the orthogonal direction (the arrow B) by the discharging rollers 209 with respect to the conveying direction A from the image forming unit 100, and the sheet P is conveyed to the discharge tray 210 through LEF. In place thereof, the sheet P may be received from the image forming unit 100 through LEF, and after being post-processed, conveyed to the discharge tray 210 through SEF.

According to the embodiments, it is possible to allow a plurality of post-processing units to be arranged in a space-saving manner, switch the sheet conveying direction smoothly, and allow processing on sheets without degrading productivity by eliminating redundant operation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sheet post-processing apparatus, comprising:
a first conveying unit configured to convey a sheet;
a holding unit configured to hold the sheet conveyed by the first conveying unit;
a first post-processing unit configured to perform a post-process on the sheet conveyed by the first conveying unit;
a second post-processing unit configured to perform a post-process on the sheet conveyed by the first conveying unit, the second post-processing unit being arranged below the first post-processing unit;
a moving unit configured to move the holding unit from the first post-processing unit to the second post-processing unit;
a second conveying unit configured to convey the sheet subjected to the post-processed by the first post-processing unit or the second post-processing unit in a direction orthogonal to a direction in which the sheet is conveyed by the first conveying unit; and
a stacking unit configured to stack the sheet conveyed by the second conveying unit.

2. The sheet post-processing apparatus according to claim 1, wherein
the holding unit holds the sheet with the sheet being held by the first conveying unit, and
after holding by the first conveying unit is released, the holding unit is moved by the moving unit.

3. The sheet post-processing apparatus according to claim 1, wherein the moving unit moves the holding unit in a circular manner.

4. The sheet post-processing apparatus according to claim 1, wherein the first conveying unit includes an entrance roller for receiving a sheet, an entrance roller driving source for rotating the entrance roller, a driven roller that is in contact with the entrance roller to form a nip for holding and conveying the sheet, and a nip formation release unit for moving the driven roller to release the formation of the nip.

5. The sheet post-processing apparatus according to claim 1, wherein
the first post-processing unit is a punching unit configured to perform a punching process on the sheet, and
the second post-processing unit is a stapling unit configured to perform a stapling process on the sheet.

6. The sheet post-processing apparatus according to claim 4, wherein the nip formation release unit releases the formation of the nip by moving the driven roller linearly obliquely to a upstream side in a direction in which the sheet received by the entrance roller is conveyed.

7. The sheet post-processing apparatus according to claim 4, wherein the nip formation releasing unit includes a guide plate to which the driven roller is attached in a rotatable manner, a nip formation release driving source, and a transmission unit configured to transmit a driving force from the driving source to the guide plate so that the driven roller moves between a first position at which the driven roller forms a nip together with the entrance roller and a second position at which the formation of the nip is released.

8. The sheet post-processing apparatus according to claim 4, wherein the entrance roller driving source and the nip formation release driving source uses a common driving source.

9. The sheet post-processing apparatus according to claim 4, wherein the entrance roller driving source is a motor, and the motor drives the entrance roller by the rotation of the motor in one direction and moves the driven roller by the rotation of the motor in the opposite direction.

10. An image forming apparatus comprising:
an image scanning unit configured to read image information;
an image forming unit configured to form an image on a sheet based on the read image, the image forming unit being arranged below the image scanning unit; and
the sheet post-processing apparatus according to claim 1 arranged in between the image scanning unit and the image forming unit, wherein the sheet on which the image has been formed is conveyed to the first conveying unit.
